(19) United States
(12) Patent Application Publication
(10) Pub. No.: US 2018/0285313 A1
(43) Pub. Date: Oct. 4, 2018

(54) ELECTRONIC APPARATUS AND RECORDING MEDIUM

(71) Applicant: KYOCERA DOCUMENT SOLUTIONS INC., OSAKA (JP)

(72) Inventor: SATOSHI IMAI, OSAKA (JP)

(21) Appl. No.: 15/934,956

(22) Filed: Mar. 24, 2018

(30) Foreign Application Priority Data
Mar. 29, 2017 (JP) 2017-064247

(51) Int. Cl. G06F 15/177; H04L 29/08

(52) U.S. Cl. CPC G06F 15/177; H04L 67/2823; H04L 67/1095

(57) ABSTRACT

An electronic apparatus includes a UTC clock, a local clock based on the UTC time and time zone information, a local time setting unit that receives a local time change request, a UTC time setting unit that, where the local time setting unit receives the local time change request, obtains UTC time via a network from a server apparatus that supplies the UTC time, compares the UTC time obtained from the server apparatus with the UTC time managed by the UTC clock, and determines whether a difference between the UTC time obtained from the server apparatus and the UTC time managed by the UTC clock is equal to or more than a threshold or less than the threshold, and a time zone setting unit that, where the UTC time setting unit determines that the difference is less than the threshold, starts a process of changing the time zone information.

### CROSS REFERENCE TO RELATED APPLICATION

This application claims the benefit of Japanese Priority Patent Application JP 2017-064247 filed Mar. 29, 2017, the entire contents of which are incorporated herein by reference.

### BACKGROUND OF THE INVENTION

### 1. Field of the Invention

The present disclosure relates to an electronic apparatus that manages local time based on UTC (Coordinated Universal Time) time and time zone information indicating a time zone in which the electronic apparatus is placed. The present disclosure further relates to a non-transitory computer readable recording medium that records an information processing program executed by the electronic apparatus.

### 2. Description of Related Art

There is known an electronic apparatus that manages local time based on UTC time and time zone information indicating a time zone in which the electronic apparatus is placed.

Such an electronic apparatus determines the local time based on the UTC time and the time zone. It is therefore desirable to correctly manage the UTC time, the time zone information, and the local time.

### SUMMARY OF THE INVENTION

According to an embodiment of the present disclosure, an electronic apparatus includes:

a processor, in which

when the processor executes an information processing program, the processor operates as

a UTC clock that manages UTC (Coordinated Universal Time) time,

a local clock that manages local time based on the UTC time and time zone information, the time zone information indicating a time zone in which the electronic apparatus is placed,

a local time setting unit that receives a local time change request to change the local time,

a UTC time setting unit that,
where the local time setting unit receives the local time change request, obtains UTC time via a network from a server apparatus that supplies the UTC time,
compares the UTC time obtained from the server apparatus with the UTC time managed by the UTC clock, and
determines whether a difference between the UTC time obtained from the server apparatus and the UTC time managed by the UTC clock is equal to or more than a threshold or less than the threshold, and

a time zone setting unit that, where the UTC time setting unit determines that the difference is less than the threshold, starts a process of changing the time zone information.

According to an embodiment of the present disclosure, a non-transitory computer readable recording medium records an information processing program that causes a processor of an electronic apparatus to operate as:

a UTC clock that manages UTC (Coordinated Universal Time) time;

a local clock that manages local time based on the UTC time and time zone information, the time zone information indicating a time zone in which the electronic apparatus is placed;

a local time setting unit that receives a local time change request to change the local time;

a UTC time setting unit that,
where the local time setting unit receives the local time change request, obtains UTC time via a network from a server apparatus that supplies the UTC time,
compares the UTC time obtained from the server apparatus with the UTC time managed by the UTC clock, and
determines whether a difference between the UTC time obtained from the server apparatus and the UTC time managed by the UTC clock is equal to or more than a threshold or less than the threshold; and

a time zone setting unit that, where the UTC time setting unit determines that the difference is less than the threshold, starts a process of changing the time zone information.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 shows a hardware configuration of an electronic apparatus according to an embodiment of the present disclosure;

FIG. 2 shows a functional configuration of the electronic apparatus; and

FIG. 3 shows an operational flow of the electronic apparatus.

### DETAILED DESCRIPTION

Hereinafter, firstly, an overview of the present technique will be described. Next, with reference to the drawings, an embodiment of the present disclosure will be described.

1. Overview of the Present Technique

An electronic apparatus that employs a system such as Linux (registered trademark) includes a UTC clock that manages UTC time, and a local clock that manages local time. The local time is based on the UTC time and time zone information, the time zone information indicating a time zone in which the electronic apparatus is placed (i.e., based on time difference in the time zone from the UTC time). For example, the electronic apparatus holds the following time zone information. The current UTC time managed by the UTC clock of the electronic apparatus is as follows, and the current local time managed by the local clock of the electronic apparatus is as follows.

Time zone: Japan (UTC+9:00)

UTC time: Jan. 10, 2017 10:12:34

Local time: Jan. 10, 2017 19:12:34

Where the electronic apparatus is physically transported and placed in a different time zone, the local-area time at the destination is different from the local time of the electronic apparatus after transportation (for example, which is displayed on a display of the electronic apparatus). From that viewpoint, it is necessary to adjust the local time of the electronic apparatus after transportation to the local-area time at the destination. In order to adjust the local time of the electronic apparatus to the local-area time at the destination, it is necessary to change the time zone information indicating the time zone before transportation, which is held by the electronic apparatus, into the time zone information indicating the time zone at the destination. For example, when the electronic apparatus is transported from the time zone “Japan” to the time zone “China”, it is necessary to manually change the time zone information (Japan), which is held by the electronic apparatus, into the following information. Then the local time is automatically changed into correct information based on the UTC time and the new time zone information as follows.

Time zone: China (UTC+8:00) (manually changed correctly)

UTC time: Jan. 10, 2017 10:12:34

Local time: Jan. 10, 2017 18:12:34 (automatically changed correctly based on the changed time zone)

However, when an electronic apparatus is physically transported and placed in a different time zone and there is a difference between the local-area time at the destination and the local time of the electronic apparatus after transportation as a result, a user may not always think that the time zone should be changed. When there is a difference between the local-area time and the local time of an electronic apparatus (for example, which is displayed on a display of the electronic apparatus), it is a main purpose of a user to adjust the local time of the electronic apparatus to the local-area time at the destination. Because of that, although the user has to change the time zone information of the electronic apparatus actually, the user may change the local time of the electronic apparatus by mistake.

For example, when an electronic apparatus is transported from the time zone “Japan” to the time zone “China”, a user may manually change the local time as follows by mistake without changing the time zone information of the electronic apparatus. Then the electronic apparatus will automatically change the UTC time as follows by mistake based on the difference between the local time changed by mistake and the unchanged time zone information, which should be changed actually.

Time zone: Japan (UTC+9:00) (unchanged, should be changed actually)

UTC time: Jan. 10, 2017 09:12:34 (automatically changed by mistake based on changed local time)

Local time: Jan. 10, 2017 18:12:34 (manually changed by mistake)

Even if a user manually changes the local time without changing the time zone information of the electronic apparatus, the local time of the electronic apparatus (for example, which is displayed on a display of the electronic apparatus) indicates the correct time (time the same as the local-area time at the destination). However, since the UTC time managed by the electronic apparatus is incorrect, for example, the following problems (1) and (2) will occur.

(1) When an electronic apparatus records a data file in a mobile recording medium such as a USB (Universal Serial Bus) memory or a built-in recording medium such as an HDD (Hard Disk Drive), typically, the electronic apparatus records a time stamp based on the UTC time in the recording medium. Then, in order to display the updated date-and-time information of the file on a display, the electronic apparatus converts the UTC time recorded in the recording medium into local time based on the time zone information, which is held by the electronic apparatus, and displays the local time obtained by conversion.

Let's say, for example, a first electronic apparatus (incorrect UTC time) records a file in a mobile recording medium, and a second electronic apparatus (correct UTC time) reads the file from the mobile recording medium. The UTC time of the first electronic apparatus, which records the file in the recording medium, is different from the UTC time of the second electronic apparatus, which reads the file from the recording medium. Because of that fact, when the second electronic apparatus converts the time stamp (incorrect UTC time) recorded in the recording medium into local time, the time stamp is converted into incorrect local time since the UTC time of the time stamp is incorrect. As a result, the updated date-and-time information displayed on the first electronic apparatus is different from the updated date-and-time information displayed on the second electronic apparatus. In more detail, the updated date-and-time information displayed on the first electronic apparatus seems to be correct. However, the updated date-and-time information displayed on the second electronic apparatus is incorrect as it turned out.

(2) According to a known technique, an electronic apparatus obtains (for example, obtains at regular intervals or at fixed time) UTC time from an NTP (Network Time Protocol) or SNIP (Simple Network Time Protocol) server apparatus. The electronic apparatus updates UTC time, which is managed by the electronic apparatus, with the UTC time obtained from the server apparatus to thereby synchronize itself with the UTC time obtained from the server apparatus. According to this technique, the electronic apparatus updates the UTC time (automatically changed by mistake), which is managed by the electronic apparatus, with the UTC time (correct) obtained from the server apparatus. Then the electronic apparatus automatically changes the local time, which seems to be correct, based on the updated UTC time (correct) and the time zone information (unchanged, should be changed actually), which is held by the electronic apparatus. As a result, the local time (which is the same as the local-area time at the destination), which seemed to be correct, is changed into a value, which seems to be incorrect (which is different from the local-area time at the destination).

In this manner, the local-area time at the destination becomes different from the local time of the electronic apparatus, once again. In this case, if a user changes the local time of the electronic apparatus once again by mistake without changing the time zone information of the electronic apparatus, the aforementioned process will be repeated again.

In view of the aforementioned circumstances, the present technique has been made to prevent a user from changing local time of an electronic apparatus by mistake although the user has to change the time zone information of the electronic apparatus actually. Accordingly, the present technique prevents, in advance, such problems described above for example from occurring.

2. Hardware Configuration of Electronic Apparatus

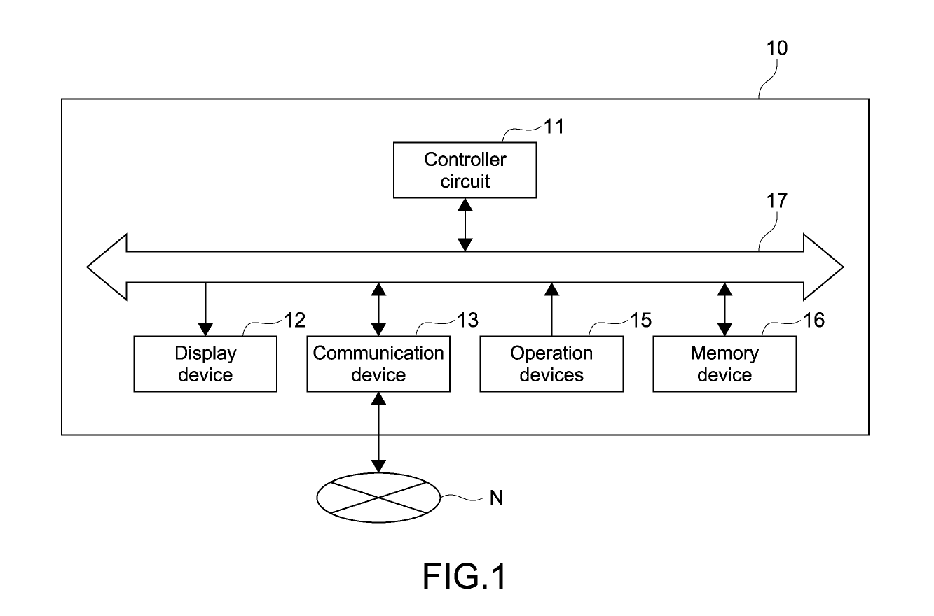

FIG. 1 shows a hardware configuration of an electronic apparatus according to an embodiment of the present disclosure.

The electronic apparatus 10 includes the controller circuit 11, and further includes the display device 12, the communication device 13, the operation devices 15, and the memory device 16 connected to the controller circuit 11 via the bus 17.

The controller circuit 11 includes a CPU (Central Processing Unit), a RAM (Random Access Memory), a ROM (Read Only Memory), a dedicated hardware circuit, and the like. The CPU of the controller circuit 11 loads a program recorded in a ROM, which is an example of a non-transitory computer readable recording medium, in the RAM and executes the program.

The memory device 16 includes a large volume memory device such as an HDD (Hard Disk Drive), and an external mobile recording medium such as a USB memory.

The display device 12 includes an LCD (Liquid Crystal Display), an organic EL (Electroluminescence) display, or the like. The display device 12 executes calculation processing on the basis of information received from the controller circuit 11 to thereby generate image signals, and displays the image signals on the display. Typically, the display device 12 may be an external display device.

The operation devices 15 include a keyboard, a mouse, various switches, and the like. The operation devices 15 detect operations input by a user, and output detected signals to the controller circuit 11.

The communication device 13 is an interface for connecting to the network N such as the Internet. The communication device 13 can communicate with the server apparatus 20 via the network N. The server apparatus 20 is an NTP or SNTP server, obtains correct UTC time based on an atomic clock or the GPS (Global Positioning System), and supplies the UTC time to the electronic apparatus 10 via the network N.

The electronic apparatus 10 may be an electronic apparatus such as a computer and an image forming apparatus (MFP, Multifunction Peripheral). Examples of the computer include a personal computer, a tablet computer, a smartphone, a wearable computer, and the like.

3. Functional Configuration of Electronic Apparatus

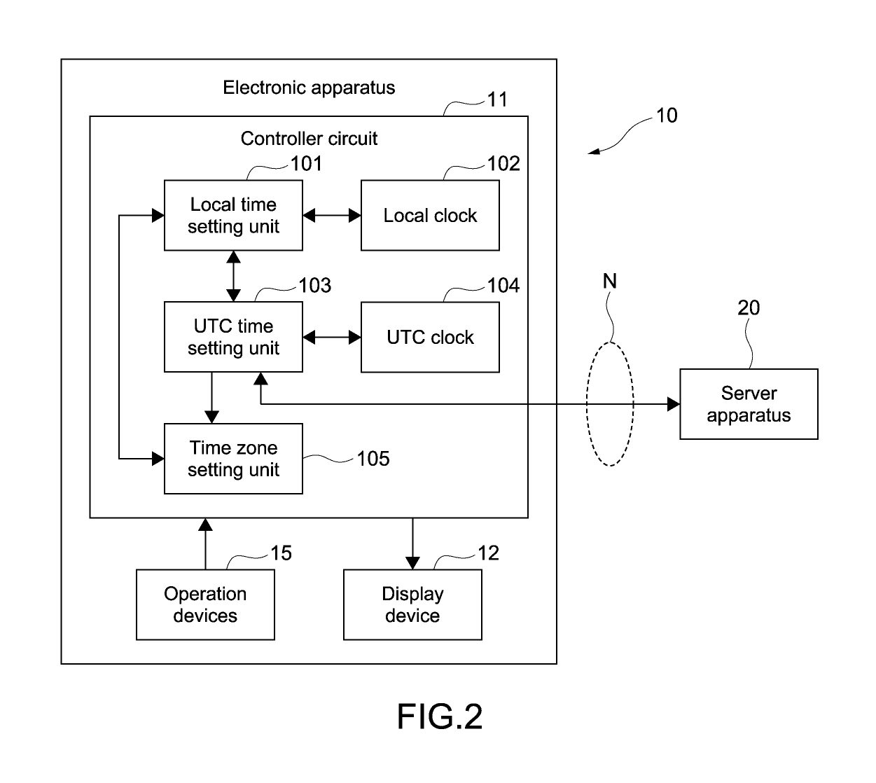

FIG. 2 shows a functional configuration of the electronic apparatus.

The controller circuit 11 of the electronic apparatus 10 loads a program recorded in a ROM, which is an example of a non-transitory computer readable recording medium, in the RAM and executes the program to thereby operate as the local time setting unit 101, the local clock 102, the UTC time setting unit 103, the UTC clock 104, and the time zone setting unit 105.

The local clock 102 manages local time based on the UTC time and time zone information, the time zone information indicating a time zone in which the electronic apparatus 10 is placed.

The local time setting unit 101 receives a local time change request to change the local time.

The UTC clock 104 manages UTC time.

The UTC time setting unit 103, where the local time setting unit 101 receives the local time change request, obtains UTC time via the network N from the server apparatus 20 that supplies the UTC time. The UTC time setting unit 103 compares the UTC time obtained from the server apparatus 20 with the UTC time managed by the UTC clock 104, and determines whether a difference between the UTC time obtained from the server apparatus and the UTC time managed by the UTC clock is equal to or more than a threshold or less than the threshold.

The time zone setting unit 105 holds the time zone information indicating a time zone in which the electronic apparatus 10 is placed. The time zone setting unit 105, where the UTC time setting unit 103 determines that the difference is less than the threshold, starts a process of changing the time zone information. Specifically, the time zone setting unit 105, as the process of changing the time zone information, asks a user if the time zone information is to be changed or not, and where it is determined that the time zone information is to be changed, receives selection of a time zone from a user, and changes the time zone information based on the selected time zone.

4. Operational Flow of Electronic Apparatus

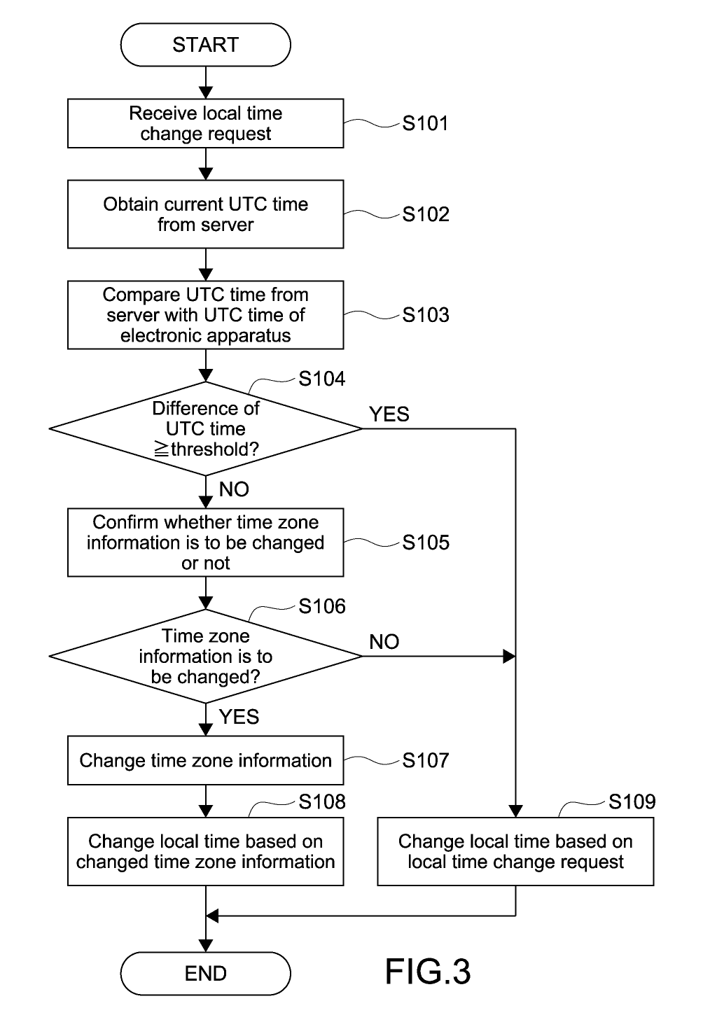

FIG. 3 shows an operational flow of the electronic apparatus.

The local time setting unit 101 detects a particular operation input in the operation devices 15 by a user as a local time change request to change local time managed by the local clock 102, and receives the local time change request (Step S101). The local time setting unit 101 informs the UTC time setting unit 103 that the local time setting unit 101 has received the local time change request.

When the UTC time setting unit 103 receives the information from the local time setting unit 101, the UTC time setting unit 103 asks the server apparatus 20 (NTP or SNTP server) about the current UTC time via the network N. The UTC time setting unit 103 obtains the current UTC time from the server apparatus 20 via the network N as a response to the inquiry (Step S102). The UTC time setting unit 103 compares the current UTC time obtained from the server apparatus 20 with the UTC time managed by the UTC clock 104 of the electronic apparatus 10, and determines whether the difference is equal to or more than a threshold or less than the threshold (Step S103).

Typically, the threshold of the difference between the current UTC time obtained from the server apparatus 20 and the UTC time managed by the UTC clock 104 is several seconds from the viewpoints of hardware specs of the electronic apparatus 10 and tolerable margins of error. Since users need the correct local time in general, the threshold may be several seconds. Alternatively, the threshold may be equal to or more than several seconds and less than several tens of minutes. For example, if a user wants to make the local time of the electronic apparatus 10 earlier than the local-area time by about 5 to 10 minutes, the threshold may be about ten and several minutes. The threshold may be variable depending on the needs of users.

Where the UTC time setting unit 103 determines that the difference between the current UTC time obtained from the server apparatus 20 and the UTC time managed by the UTC clock 104 is less than the threshold (Step S104, NO), the UTC time setting unit 103 informs the time zone setting unit 105 of the determined result.

Where the time zone setting unit 105 receives the information from the UTC time setting unit 103, the time zone setting unit 105 starts the process of changing the time zone information. Specifically, firstly, the time zone setting unit 105 displays a confirmation window on the display device 12, and asks a user if the time zone information is to be changed or not (Step S105).

A reason why a user is asked if the time zone information is to be changed or not will be described. The difference between the current UTC time obtained from the server apparatus 20 and the UTC time managed by the UTC clock 104 is less than the threshold (Step S104, NO). It means that the UTC time managed by the UTC clock 104 is correct. Possibly, the user may thus want to change the local time (Step S101) because of a reason other than a reason that the local clock 102 is wrong or the like. Rather, it is highly likely that the local time managed by the local clock 102 becomes different from the local-area time at the destination because the electronic apparatus 10 is transported to a different time zone. From that viewpoint, the time zone setting unit 105 displays the confirmation window on the display device 12, and asks a user if the time zone information is to be changed or not (Step S105).

Where the time zone setting unit 105 detects a particular operation input in the operation devices 15 by the user, the time zone setting unit 105 determines that the time zone information is to be changed (Step S106, YES). Then the time zone setting unit 105 receives the particular operation input in the operation devices 15 from the user as selection of a time zone, and changes the time zone information based on the selected time zone (Step S107). The time zone setting unit 105 informs the local time setting unit 101 of the changed time zone information.

The local time setting unit 101 obtains the changed time zone information from the time zone setting unit 105. The local time setting unit 101 changes the local time managed by the local clock 102 based on the changed time zone information and the UTC time managed by the UTC clock 104 (Step S108).

Meanwhile, where the UTC time setting unit 103 determines that the difference between the current UTC time obtained from the server apparatus 20 and the UTC time managed by the UTC clock 104 is equal to or more than the threshold (Step S104, YES), the UTC time setting unit 103 informs the local time setting unit 101 of the determined result.

Where the local time setting unit 101 receives the information from the UTC time setting unit 103, the local time setting unit 101 changes the local time managed by the local clock 102 (Step S109) based on the local time change request (Step S101).

This case is different from the aforementioned case (Step S104, NO). The difference between the current UTC time obtained from the server apparatus 20 and the UTC time managed by the UTC clock 104 is equal to or more than the threshold (Step S104, YES). It means that the UTC time managed by the UTC clock 104 is incorrect. It may happen where, for example, the UTC clock 104 of the electronic apparatus 10 returns to the default value because the electronic apparatus 10 is once powered off or because a battery runs out. Possibly, the user may thus want to change the local time (Step S101) because the local clock 102 is wrong or the like. From that viewpoint, the local time setting unit 101 changes the local time managed by the local clock 102 (Step S109) without asking a user if the time zone information is to be changed or not (Step S105).

Note that, also, where the time zone setting unit 105 detects a particular operation input in the operation devices 15 from a user and determines that the time zone information is to be unchanged (Step S106, NO), the local time setting unit 101 changes the local time managed by the local clock 102 (Step S109).

5. Conclusion

Where the electronic apparatus is physically transported and placed in a different time zone, the local-area time at the destination is different from the local time of the electronic apparatus after transportation (for example, which is displayed on a display of the electronic apparatus). From that viewpoint, it is necessary to adjust the local time of the electronic apparatus after transportation to the local-area time at the destination. In order to adjust the local time of the electronic apparatus to the local-area time at the destination, it is necessary to change the time zone information indicating the time zone before transportation, which is held by the electronic apparatus, into the time zone information indicating the time zone at the destination. Then the local time of the electronic apparatus is automatically changed into correct information based on the UTC time and the new time zone information.

However, when an electronic apparatus is physically transported and placed in a different time zone and there is a difference between the local-area time at the destination and the local time of the electronic apparatus after transportation as a result, a user may not always think that the time zone should be changed. When there is a difference between the local-area time and the local time of an electronic apparatus (for example, which is displayed on a display of the electronic apparatus), it is a main purpose of a user to adjust the local time of the electronic apparatus to the local-area time at the destination. Because of that, although the user has to change the time zone information of the electronic apparatus actually, the user may change the local time of the electronic apparatus by mistake.

In view of the aforementioned circumstances, according to the present embodiment, every time the electronic apparatus 10 receives a local time change request (Step S101) as a trigger, the electronic apparatus 10 obtains the current UTC time from the server apparatus 20 without fail (Step S102), which is executed in background for a user. Then the electronic apparatus 10 compares the current UTC time obtained from the server apparatus 20 with the UTC time managed by the UTC clock 104 (Step S103). Then, only after it is determined that the UTC time managed by the UTC clock 104 is correct (Step S104, NO), the electronic apparatus 10 displays the confirmation window on the display device 12, and asks the user if the time zone information is to be changed or not (Step S105).

Therefore, when the electronic apparatus 10 is transported to a different time zone and there is a difference between the local-area time at the destination and the local time of the electronic apparatus 10 after transportation as a result, the user has to change the time zone information of the electronic apparatus 10 apparatus actually. It is possible to prevent the user from changing the local time of the electronic apparatus 10 by mistake. Accordingly, the present technique can prevent, in advance, such problems described above for example from occurring.

Meanwhile, where the UTC time managed by the UTC clock 104 is incorrect (Step S104, YES), the electronic apparatus 10 changes the local time managed by the local clock 102 (Step S109) without asking a user if the time zone information is to be changed or not (Step S105).

Therefore the electronic apparatus 10 can change the local time managed by the local clock 102 (Step S109) after confirming that it is highly likely that not the time zone information but the local time should be changed. In addition, where it is highly likely that not the time zone information but the local time should be changed, a user has no trouble to input operations to determine whether the time zone information is to be changed or not in the operation devices 15.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic apparatus, comprising:
a processor, wherein
when the processor executes an information processing program, the processor operates as
a UTC clock that manages UTC (Coordinated Universal Time) time,
a local clock that manages local time based on the UTC time and time zone information, the time zone information indicating a time zone in which the electronic apparatus is placed,
a local time setting unit that receives a local time change request to change the local time,
a UTC time setting unit that,
where the local time setting unit receives the local time change request, obtains UTC time via a network from a server apparatus that supplies the UTC time,
compares the UTC time obtained from the server apparatus with the UTC time managed by the UTC clock, and
determines whether a difference between the UTC time obtained from the server apparatus and the UTC time managed by the UTC clock is equal to or more than a threshold or less than the threshold, and
a time zone setting unit that, where the UTC time setting unit determines that the difference is less than the threshold, starts a process of changing the time zone information.

2. The electronic apparatus according to claim 1, wherein
the time zone setting unit, as the process of changing the time zone information,
asks a user if the time zone information is to be changed or not, and
where it is determined that the time zone information is to be changed, receives selection of a time zone from the user, and changes the time zone information based on the selected time zone, and
the local time setting unit changes the local time based on the UTC time and the time zone information changed by the time zone setting unit.

3. The electronic apparatus according to claim 2, wherein
where the time zone setting unit determines that the time zone information is to be unchanged,
the local time setting unit changes the local time.

4. The electronic apparatus according to claim 1, wherein
the local time setting unit further, where the UTC time setting unit determines that the difference is equal to or more than the threshold, changes the local time.

5. A non-transitory computer readable recording medium that records an information processing program that causes a processor of an electronic apparatus to operate as:
a UTC clock that manages UTC (Coordinated Universal Time) time;
a local clock that manages local time based on the UTC time and time zone information, the time zone information indicating a time zone in which the electronic apparatus is placed;
a local time setting unit that receives a local time change request to change the local time;
a UTC time setting unit that,
where the local time setting unit receives the local time change request, obtains UTC time via a network from a server apparatus that supplies the UTC time,
compares the UTC time obtained from the server apparatus with the UTC time managed by the UTC clock, and
determines whether a difference between the UTC time obtained from the server apparatus and the UTC time managed by the UTC clock is equal to or more than a threshold or less than the threshold; and
a time zone setting unit that, where the UTC time setting unit determines that the difference is less than the threshold, starts a process of changing the time zone information.
